(19) United States
(12) Patent Application Publication
(10) Pub. No.: US 2015/0151412 A1
(43) Pub. Date: Jun. 4, 2015

(54) Socket Tool Adapted for Nuts of Varying Size

(71) Applicant: Timmy Chen, Taichung City (TW)

(72) Inventor: Timmy Chen, Taichung City (TW)

(21) Appl. No.: 14/093,618

(22) Filed: Dec. 2, 2013

(51) Int. Cl. B25B 13/10

(52) U.S. Cl. CPC B25B 13/102

(57) ABSTRACT

A socket tool adapted for nuts of varying size contains: a socket assembly and a connector assembly. The socket assembly includes a hollowly cylindrical body having two slots, a first outer socket having first inner ratchet teeth, and a second outer socket having second inner ratchet teeth. A size of the first inner ratchet teeth is different from that of the second inner ratchet teeth. The first inner socket has first outer ratchet teeth for retaining with the first inner ratchet teeth, a first inner toothed portion, and a first coupling segment. The second inner socket has second outer ratchet teeth for retaining with the second inner ratchet teeth and a second inner toothed portion. A size of the second inner toothed portion is different from that of the first inner toothed portion. The connector assembly includes a shaft, a movable sleeve, and two joining extensions.

### FIELD OF THE INVENTION

The present invent relates to a socket tool adapted for nuts of varying size in which a hollowly cylindrical body is applicable for nuts of four varying sizes to reduce use cost and to enhance using requirement.

### BACKGROUND OF THE INVENTION

Referring to FIG. 14, a conventional socket tool contains a body 1, a first connector 11 extending outwardly from a first end of the body 1 so as to fit with a hand tool or a power tool, a second connector 12 formed on a second end of the body 1 so as to fit with a screw or a nut. In operation, the first connector 11 is fitted with the hand tool or the power tool, and the second connector fitting with the screw or the nut is rotated so as to unscrew or screw the screw. However, the first connector 11 is only applicable for the screw or the nut with a fixed size.

As shown in FIGS. 15 and 16, a conventional socket tool contains a body 2, a first connector 21 extending outwardly from a first end of the body 2 so as to fit with a hand tool or a power tool, and a second connector 22 arranged on a second end of the body 2 so as to fit with a screw or a nut. The second connector 22 has an outer socket 221 and an inner socket 222, wherein an outer diameter of the inner socket 222 is similar to an inner diameter of the outer socket 221 so that the inner socket 222 fits with the outer socket 221, and the outer socket 221 moves along the inner socket 222. This conventional socket is therefore adapted for two nuts with two different sizes.

The present invention has arisen to mitigate and/or obviate the afore-described disadvantages.

### SUMMARY OF THE INVENTION

The primary object of the present invention is to provide a socket tool adapted for nuts of varying size in which a first outer socket is fitted with a first inner socket, a second outer socket is fitted with a second inner socket, and a connecting assembly is used to drive or limit the first outer socket, the first inner socket, the second outer socket and the second inner socket so that a hollowly cylindrical body is applicable for nuts of four varying sizes to reduce use cost and to enhance using requirement.

### BRIEF DESCRIPTION OF THE DRAWINGS

FIG. 1 is a perspective view showing the exploded components of a socket tool adapted for nuts of varying size according to a preferred embodiment of the present invention.

FIG. 2 is a perspective view showing the assembly of the socket tool adapted for the nuts of varying size according to the preferred embodiment of the present invention.

FIG. 3 is a plan view showing the assembly of the socket tool adapted for the nuts of varying size according to the preferred embodiment of the present invention.

FIG. 4 is a cross sectional view showing the assembly of the socket tool adapted for the nuts of varying size according to the preferred embodiment of the present invention.

FIG. 5 is a cross sectional view showing the assembly of a hollowly cylindrical body of the socket tool adapted for the nuts of varying size according to the preferred embodiment of the present invention.

FIG. 6 is a cross sectional view showing the operation of the socket tool adapted for the nuts of varying size according to the preferred embodiment of the present invention.

FIG. 7 is another cross sectional view showing the operation of the socket tool adapted for the nuts of varying size according to the preferred embodiment of the present invention.

FIG. 8 is also cross sectional view showing the operation of the socket tool adapted for the nuts of varying size according to the preferred embodiment of the present invention.

FIG. 9 is a plan view showing the operation of the socket tool adapted for the nuts of varying size according to the preferred embodiment of the present invention.

FIG. 10 is another plan view showing the operation of the socket tool adapted for the nuts of varying size according to the preferred embodiment of the present invention.

FIG. 11 is also another plan view showing the operation of the socket tool adapted for the nuts of varying size according to the preferred embodiment of the present invention.

FIG. 12 is also another cross sectional view showing the operation of the socket tool adapted for the nuts of varying size according to the preferred embodiment of the present invention.

FIG. 13 is still another cross sectional view showing the operation of the socket tool adapted for the nuts of varying size according to the preferred embodiment of the present invention.

FIG. 14 is a perspective view of a conventional socket tool.

FIG. 15 is a perspective view of another conventional socket tool.

FIG. 16 is a cross section view of FIG. 15.

### DETAILED DESCRIPTION OF THE PREFERRED EMBODIMENTS

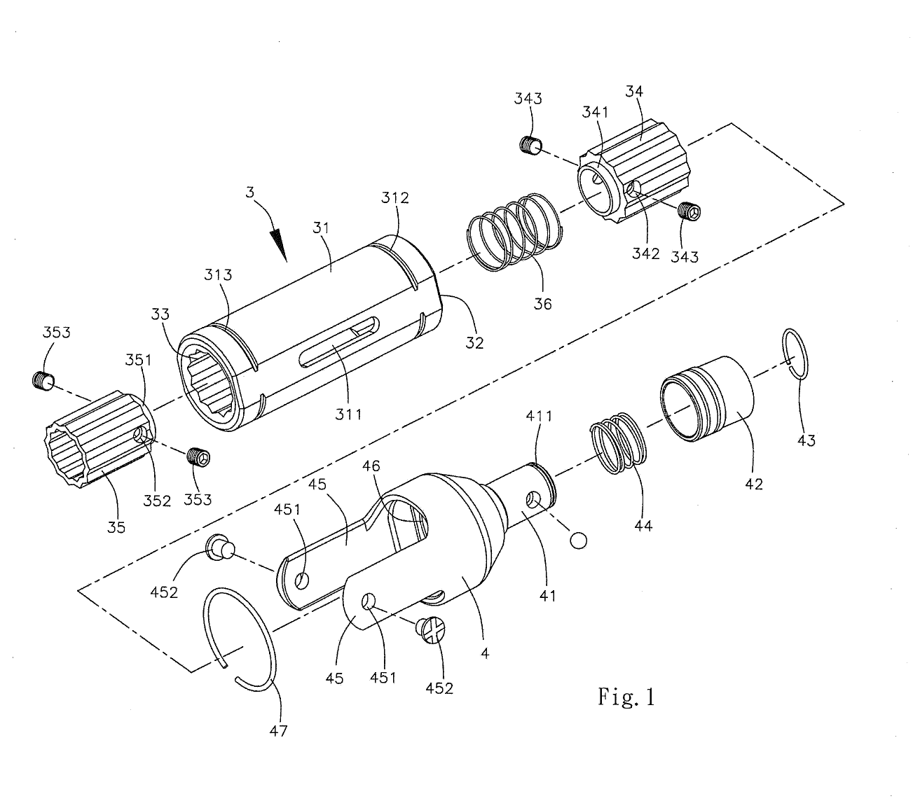

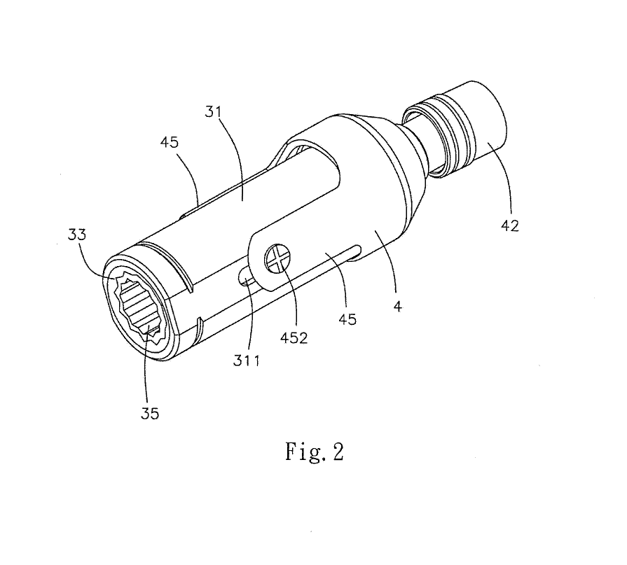

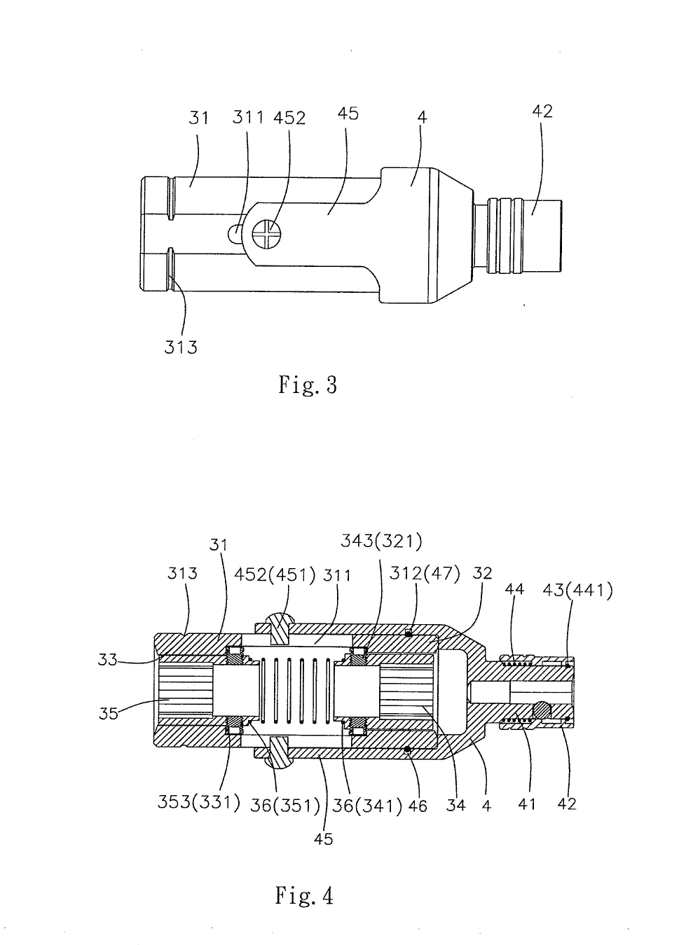

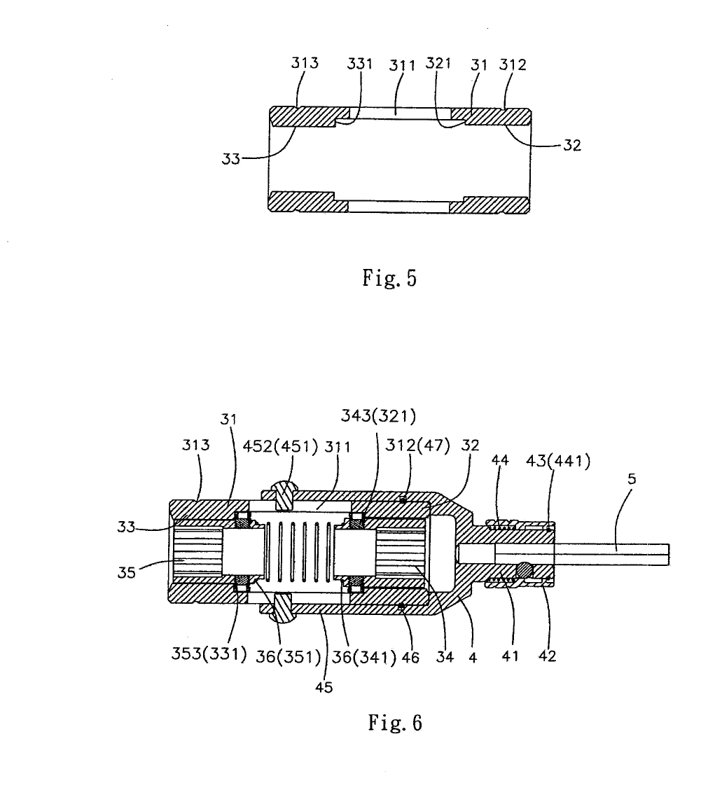

With reference to FIGS. 1-5, a socket tool adapted for nuts of varying size according to a preferred embodiment of the present invention comprises a socket assembly 3 and a connector assembly 4.

The socket assembly 3 includes a hollowly cylindrical body 31, the hollowly cylindrical body 31 has two opposite slots 311 passing therethrough, a first limiting recess 312 and a second limiting recess 313 formed proximate to two ends of an outer wall thereof. The hollowly cylindrical body 31 also has a first outer socket 32 and a second outer socket 33 defined on two ends thereof. The first outer socket 32 has first inner ratchet teeth of varying size so as to fit with nuts of varying size, and the second outer socket 33 has second inner ratchet teeth of varying size so as to fit with nuts of varying size. The first outer socket 32 also has a first shoulder 321 arranged therearound, and the second outer socket 33 has a second shoulder 331 arranged therearound.

The first outer socket 32 is used to fit with a first inner socket 34. The first inner socket 34 has first outer ratchet teeth defined on an outer wall thereof so as to retain with the first inner ratchet teeth of the first outer socket 32, a first inner toothed portion formed around an inner wall thereof so as to retain with the nuts of varying size, and a first coupling segment 341 arranged on a distal end thereof so as to abut against a first end of a resilient element 36 mounted in the hollowly cylindrical body 31. The first inner socket 34 also has two opposite first orifices 342 (each first orifice 342 is a threaded hole) defined on the outer wall thereof so as to connect with two first connecting elements 343 (each first connecting element 343 is a screw), wherein a largest outer diameter between the two first connecting elements 343 extending out of the first inner socket 34 is smaller than an inner diameter of the hollowly cylindrical body 31 and is larger than an inner diameter of the first shoulder 321 of the first outer socket 32.

The second outer socket 33 is applied to fit with a second inner socket 35. The second inner socket 35 has second outer ratchet teeth defined on an outer wall thereof so as to retain with the second inner ratchet teeth of the second outer socket 33, a second inner toothed portion formed around an inner wall thereof, wherein a size of the second inner toothed portion of the second inner socket 35 is different from that of the first inner toothed portion of the first inner socket 34, and a second coupling segment 351 arranged on a distal end thereof so as to abut against a second end of the resilient element 36. The second inner socket 35 also has two opposite second orifices 352 (each second orifice 352 is a threaded hole) defined on the outer wall thereof so as to connect with two second connecting elements 353 (each second connecting element 353 is a screw), wherein a largest outer diameter between the two second connecting elements 353 extending out of the second inner socket 35 is smaller than the inner diameter of the hollowly cylindrical body 31 and is larger than an inner diameter of the second shoulder 331 of the second outer socket 33.

The connector assembly 4 includes a shaft 41 formed on a first end thereof, a movable sleeve 42 fitted on the shaft 41, a C-ring 43 retained in a notch 411 of the shaft 41, a compression spring 44 defined between the shaft 41 and the movable sleeve 42 so as to horizontally move the movable sleeve 42 along the shaft 41, two joining extensions 45 extending outwardly from a second end thereof, wherein each joining extension 45 has a third orifice 451 defined thereon (the third orifice 451 is a threaded hole) so as to connect with a third connecting element 452 (the third connecting element 452 is a screw). A bottom end of the third connecting element 452 is inserted into a respective one of the two opposite slots 311 of the hollowly cylindrical body 31, and a shape of an inner peripheral wall of the connector assembly 4 is identical to that of an outer diameter of the hollowly cylindrical body 31. The connector assembly 4 also includes a trench 46 formed around the inner wall thereof so as to retain with a C-shaped retainer 47.

In assembly, the first coupling segment 341 of the first inner socket 34 is biased against the resilient element 36, and then the first inner socket 34 and the resilient element 36 are fitted into the hollowly cylindrical body 31 so that the two first connecting elements 343 are fixed in the two opposite first orifices 342 of the first inner socket 34 from the two opposite slots 311 of the hollowly cylindrical body 31, wherein the largest outer diameter between the two first connecting elements 343 extending out of the first inner socket 34 is smaller than the inner diameter of the hollowly cylindrical body 31 and is larger than the inner diameter of the first shoulder 321 of the first outer socket 32. Thereafter, the second outer socket 33 is fitted with the second inner socket 35 so that the second coupling segment 351 of the second inner socket 35 abuts against the second end of the resilient element 36, and the two second connecting elements 353 are secured in the two opposite second orifices 352 of the second inner socket 35 from the two opposite slots 311 of the hollowly cylindrical body 31, wherein the largest outer diameter between the two second connecting elements 353 extending out of the second inner socket 35 is smaller than the inner diameter of the hollowly cylindrical body 31 and is larger than the inner diameter of the second shoulder 331 of the second outer socket 33, such that the resilient element 36 pushes the first inner socket 34 and the second inner socket 35 so that the two first connecting elements 343 of the first inner socket 34 contact with the first shoulder 321, and the two second connecting elements 353 of the second inner socket 35 are biased against the second shoulder 321, hence the first inner socket 34 and the second inner socket 35 are limited in the hollowly cylindrical body 31. In the meantime, the movable sleeve 42 and the compression spring 44 are fitted on the shaft 41 of the connector assembly 4, and the C-shaped retainer 47 is retained in the notch 411 of the shaft 41, the two joining extensions 45 of the connector assembly 4 are fitted in the two opposite slots 311 of the hollowly cylindrical body 31, and two third connecting elements 452 are screwed with two third orifices 451 of the two joining extensions 45, two bottom ends of the two third connecting elements 452 are inserted into the two opposite slots 311 of the hollowly cylindrical body 31, such that the connector assembly 4 moves on the hollowly cylindrical body 31, and the C-shaped retainer 47 of the connector assembly 4 is retained in the first limiting recess 312 of the hollowly cylindrical body 31 so that the connector assembly 4 is limited on the hollowly cylindrical body 31 of socket assembly 3.

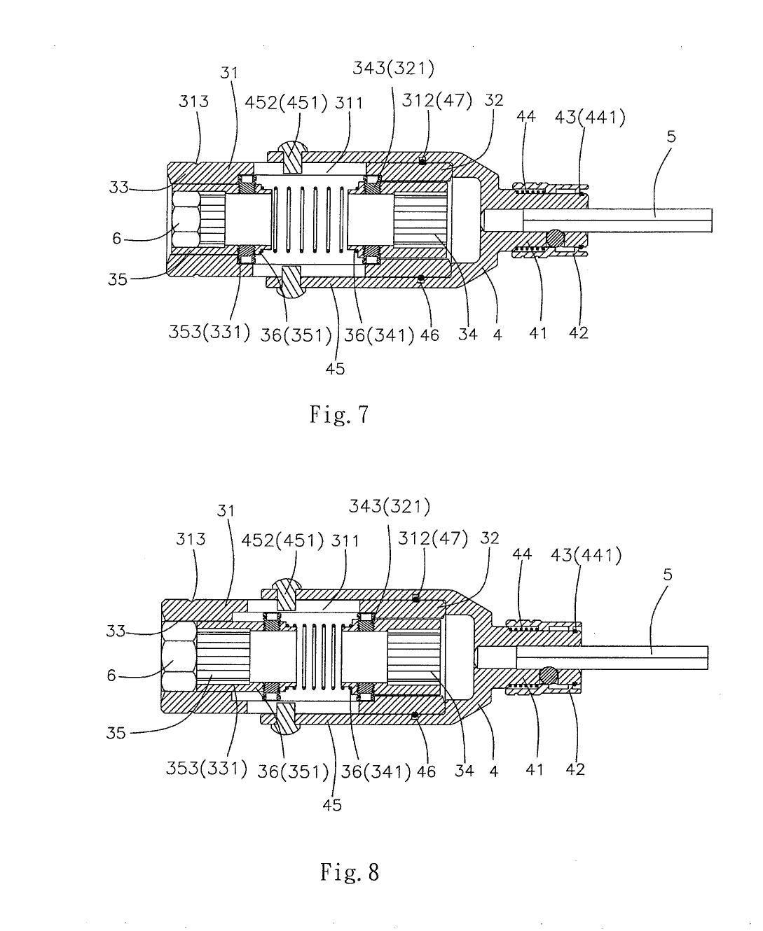

Referring to FIG. 6, in operation, a connection rod 5 is fitted with the movable sleeve 42 of the connector assembly 4 so as to drive any one of a power tool, a pneumatic tool and a hand tool. As shown in FIG. 7, when desiring to screw or unscrew a nut 6 with an outer diameter for matching with a size of the second inner toothed portion of the second inner socket 35, the second inner socket 35 is fitted with the nut 6, and the connection rod 5 is forced to drive the connector assembly 4 to rotate, wherein the inner peripheral wall of the connector assembly 4 fits with the outer wall of the hollowly cylindrical body 31 so that the hollowly cylindrical body 31 is driven by the connector assembly 4 to rotate, hence the second inner ratchet teeth of the second outer socket 33 drive the second outer ratchet teeth of the second inner socket 35 to rotate, thereby screwing or unscrewing the nut 6.

As illustrated in FIG. 8, when intending to screw or unscrew a nut 6 with an outer diameter for cooperating with a size of the second inner ratchet teeth of the second outer socket 33, the second outer socket 33 is fitted with the nut 6, and an inner rim of the nut 6 pushes the second inner socket 35 into the hollowly cylindrical body 31 so as drive the connection rod 5, and then the connector assembly 4 is driven by the connection rod 5 to rotate, the inner peripheral wall of the connector assembly 4 fits with the outer wall of the hollowly cylindrical body 31 so that the hollowly cylindrical body 31 is driven by the connector assembly 4 to rotate, hence the second inner ratchet teeth of the second outer socket 33 drive the nut 6 to rotate, thus screwing or unscrewing the nut 6. After the second outer socket 33 is removed from the nut 6, the second inner socket 35 is pushed by the resilient element 36 to move toward the second outer socket 33, such that the two second connecting elements 353 of the second inner socket 35 engage with the second shoulder 331 of the hollowly cylindrical body 31.

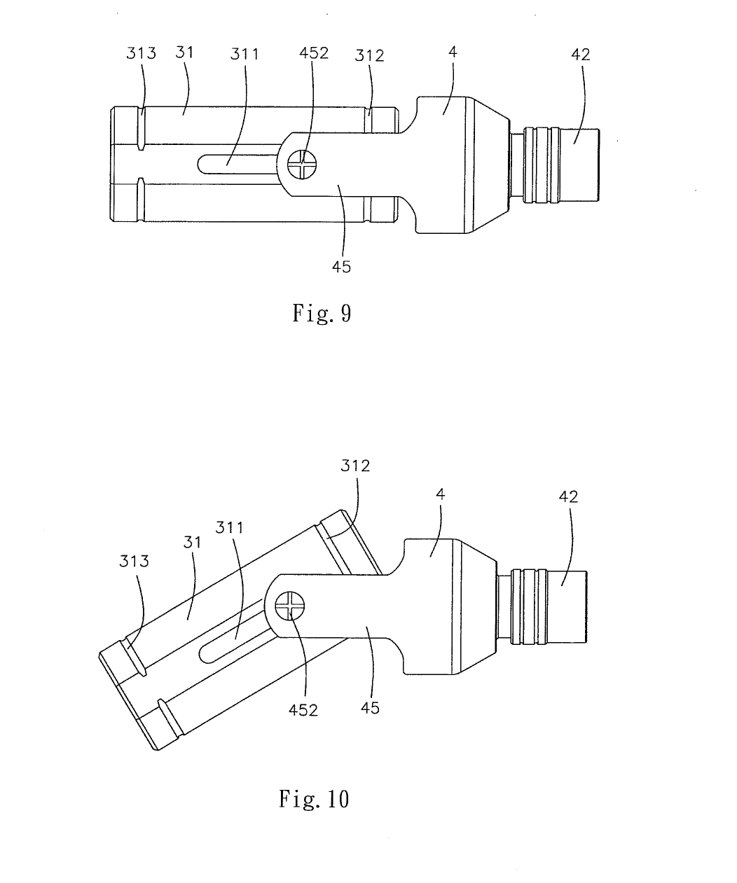

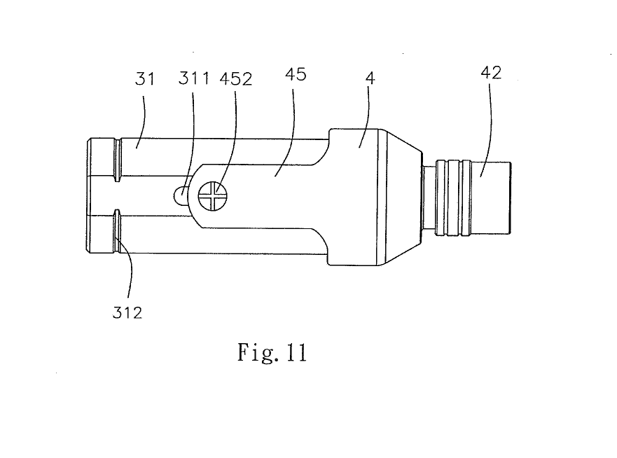

With reference to FIG. 9, as desiring to use the first outer socket 32, the hollowly cylindrical body 31 is pulled toward the connector assembly 4 so that the first limiting recess 312 of the hollowly cylindrical body 31 disengages from the C-shaped retainer 47 of the connector assembly 4 (in this moment, the two bottom ends of the two third connecting elements 452 are inserted into the two opposite slots 311 of the hollowly cylindrical body 31, such that when the connector assembly 4 moves relative to the hollowly cylindrical body 31, the two third connecting elements 452 of the connector assembly 4 are retained in the two opposite slots 311 of the hollowly cylindrical body 31 so as to position the connector assembly 4), and the inner peripheral wall of the connector assembly 4 disengages from the hollowly cylindrical body 31. As shown in FIG. 10, after the hollowly cylindrical body 31 is rotated toward a predetermined position along the two third connecting elements 452 of the connector assembly 4, it is pushed into the connector assembly 4 so that the second limiting recess 313 of the hollowly cylindrical body 31 is engaged with the C-shaped retainer 47 of the connector assembly 4 (as illustrated in FIG. 11).

Referring to FIG. 12, as desiring to screw or unscrew a nut 6 with an outer diameter for mating with a size of the first inner toothed portion of the first inner socket 34, the first inner socket 34 is fitted with the nut 6 so as to drive the connection rod 5, and then the connector assembly 4 is driven by the connection rod 5 to rotate, wherein the inner peripheral wall of the connector assembly 4 fits with the outer wall of the hollowly cylindrical body 31 so as to drive the hollowly cylindrical body 31 to rotate, hence the first inner ratchet teeth of the first outer socket 32 drive the first outer ratchet teeth of the first inner socket 34 to rotate, thus screwing or unscrewing the nut 6.

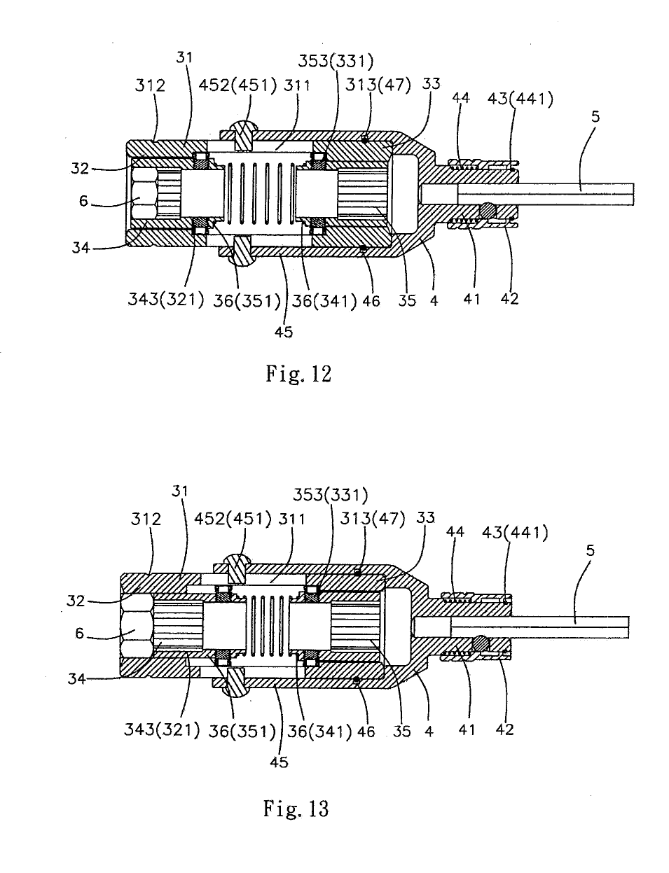

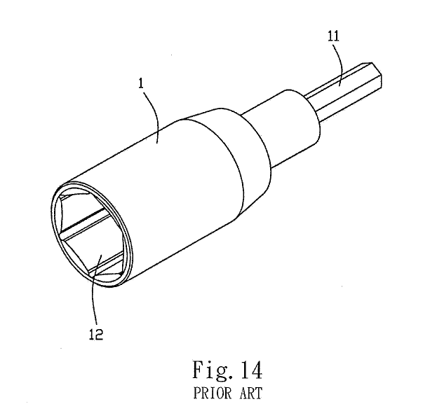

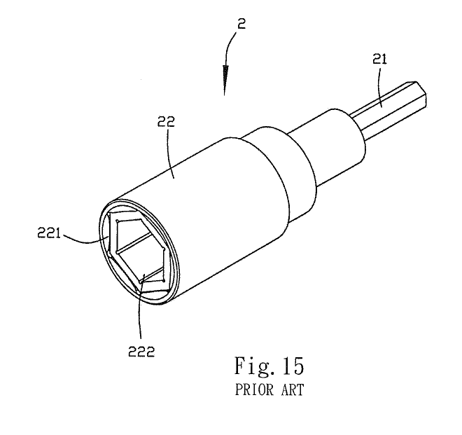

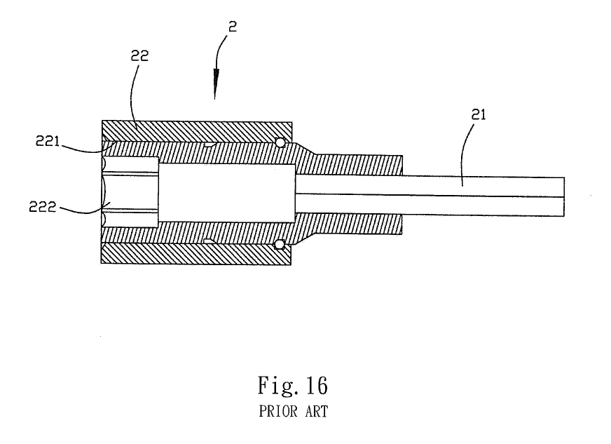

Referring to FIG. 13, as intending to screw or unscrew a nut 6 with an outer diameter for matching with a size of the first inner ratchet teeth of the first outer socket 32, the first outer socket 32 is fitted with the nut 6 so that an outer rim of the nut 6 pushes the first inner socket 34 into the hollowly cylindrical body 31, the first inner socket 34 drives the connection rod 5 to rotate, and the connector assembly 4 is driven by the connection rod 5 to rotate, wherein the inner peripheral wall of the connector assembly 4 fits with the outer wall of the hollowly cylindrical body 31 so as to drive the hollowly cylindrical body 31 to rotate, such that the first inner ratchet teeth of the first outer socket 32 drive the nut 6 to rotate, thus screwing or unscrewing the nut 6. After the first outer socket 32 is removed from the nut 6, the first inner socket 34 is pushed by the resilient element 36 to move toward the first outer socket 34 so that the two first connecting elements 343 of the first inner socket 34 contact with the first shoulder 321 of the hollowly cylindrical body 31, thereby fixing the first inner socket 34.

Accordingly, the first outer socket is fitted with the first inner socket, the second outer socket is fitted with the second inner socket, and the connecting assembly is used to drive or limit the first outer socket, the first inner socket, the second outer socket and the second inner socket so that the hollowly cylindrical body is applicable for nuts of four varying sizes to reduce use cost and to enhance using requirement.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A socket tool adapted for nuts of varying size comprising:
a socket assembly and a connector assembly;
the socket assembly including a hollowly cylindrical body, the hollowly cylindrical body having two opposite slots passing therethrough, a first outer socket and a second outer socket defined on two ends thereof; the first outer socket having first inner ratchet teeth, and the second outer socket having second inner ratchet teeth;
wherein
a size of the first inner ratchet teeth of the first outer socket is different from that of the second inner ratchet teeth of the second outer ratchet teeth;
the first outer socket is fitted with the first inner socket, the first inner socket has first outer ratchet teeth defined on an outer wall thereof so as to retain with the first inner ratchet teeth of the first outer socket, such that the first inner socket is fitted with and is limited by the first outer socket, and the first inner socket also has a first inner toothed portion formed around an inner wall thereof and a distal end for abutting against a first end of a resilient element mounted in the hollowly cylindrical body;
the second outer socket is fitted with a second inner socket, the second inner socket has second outer ratchet teeth defined on an outer wall thereof so as to retain with the second inner ratchet teeth of the second outer socket, such that the second inner socket is fitted with and is limited by the second outer socket;
the second inner socket also has a second inner toothed portion formed around an inner wall thereof, wherein a size of the second inner toothed portion of the second inner socket is different from that of the first inner toothed portion of the first inner socket;
the connector assembly includes a shaft formed on a first end thereof, a movable sleeve fitted on the shaft, and two joining extensions extending outwardly from a second end thereof, wherein each joining extension has a third orifice defined thereon so as to connect with a third connecting element, and a bottom end of the third connecting element is inserted into a respective one of the two opposite slots of the hollowly cylindrical body.

2. The socket tool adapted for the nuts of varying size as claimed in claim 1, wherein the hollowly cylindrical body also has a first limiting recess and a second limiting recess formed proximate to two ends of an outer wall thereof.

3. The socket tool adapted for the nuts of varying size as claimed in claim 1, wherein the first outer socket also has a first shoulder arranged therearound, and the second outer socket has a second shoulder arranged therearound.

4. The socket tool adapted for the nuts of varying size as claimed in claim 1, wherein the first inner socket further has a first coupling segment arranged on the distal end thereof so as to abut against the first end of the resilient element, the second inner socket further has a second coupling segment arranged on a distal end thereof so as to abut against a second end of the resilient element.

5. The socket tool adapted for the nuts of varying size as claimed in claim 1, wherein the first inner socket also has two opposite first orifices defined on the outer wall thereof so as to connect with two first connecting elements, wherein a largest outer diameter between the two first connecting elements extending out of the first inner socket is smaller than an inner diameter of the hollowly cylindrical body and is larger than an inner diameter of the first shoulder of the first outer socket; the second inner socket also has two opposite second orifices defined on the outer wall thereof so as to connect with two second connecting elements, wherein a largest outer diameter between the two second connecting elements extending out of the second inner socket is smaller than the inner diameter of the hollowly cylindrical body and is larger than an inner diameter of the second shoulder of the second outer socket.

6. The socket tool adapted for the nuts of varying size as claimed in claim 5, wherein each first orifice and each second orifice are a threaded hole, each first connecting element and each second connecting element are a screw.

7. The socket tool adapted for the nuts of varying size as claimed in claim 1, wherein the connector assembly also includes a C-ring retained in a notch of the shaft and includes a compression spring defined between the shaft and the movable sleeve so as to horizontally move the movable sleeve along the shaft.

8. The socket tool adapted for the nuts of varying size as claimed in claim 1, wherein the third orifice of each joining extension of the connector assembly is a threaded hole so as to connect with the third connecting element, and the third connecting element is a screw.

9. The socket tool adapted for the nuts of varying size as claimed in claim 1, wherein a shape of an inner peripheral wall of the connector assembly is identical to that of an outer diameter of the hollowly cylindrical body.

10. The socket tool adapted for the nuts of varying size as claimed in claim 1, wherein the connector assembly further includes a trench formed around the inner wall thereof so as to retain with a C-shaped retainer.
